(19) United States
(12) Patent Application Publication
(10) Pub. No.: US 2007/0126577 A1
(43) Pub. Date: Jun. 7, 2007

(54) Door latch position sensor

(76) Inventors: Hugo A. Cervantes, Chihuahua (MX); Alejandrina B. Navarro, Chihuahua (MX)

Correspondence Address: DELPHI TECHNOLOGIES, INC., M/C 480-410-202, PO BOX 5052, TROY, MI, 48007, US

(21) Appl. No.: 11/293,958

(22) Filed: Dec. 5, 2005

(51) Int. Cl. G08B 13/08; G08B 21/00

(52) U.S. Cl. 340/547; 340/686.1

(57) ABSTRACT

A door latch position system includes a magnet on a wheel that fits over the hub of the latch and a Hall effect sensor with a circuit board that is mounted on the vehicle body. Alternatively, the magnet and Hall sensor can both be attached to the circuit board, and a metal piece can be overmolded onto a cam portion of the wheel. In either case, the signal from the Hall sensor represents the position of the latching mechanism.

### FIELD OF THE INVENTION

The present invention relates generally to sensors for sensing the position of latching mechansims on vehicle doors and other components.

### BACKGROUND OF THE INVENTION

Automobiles have door latches that control the automobile door's ability to open or stay shut. It is necessary to sense the closing transition, from the moment the door strikes the body of the car until it is completely closed, and vice-versa for reasons such as to energize safety warning lamps of “door ajar,” for auto locking, etc.

Current door/latch position sensors use mechanical switches as part of their sensing mechanism to determine the positional state of the door. These mechanical switches are susceptible to breaking, have short lives because they physically contact other mechanical components, etc. U.S. Pat. No. 5,038,135 teaches embedding two magnets in the latching mechanism and two sensors in a nearby structure to provide on/off pulses when the door latch opens and closes. But since only discrete signals are provided, the exact position of the latching mechanism is unknown. As recognized by the present invention, it would be advantageous to use only a single magnet and sensor and moreover to know the exact position of the latching mechanism. One application of this would be to control a mechanism that helps move the door from door ajar position to completely closed without the need for a person to exert additional force.

### SUMMARY OF THE INVENTION

As a first embodiment, a door latch position system includes a single magnet on a wheel that is engaged with a door latching mechanism in a way that will cause the magnet to rotate with the latching mechanism. For example, the magnet may be engaged with a hub of a rotatable door latch mechanism. A magnetic field sensor that is nearby the magnet provides an electrical output in response to sensing the moving magnetic field when the magnet moves relative to the sensor. The electrical signal represents the position of the latching mechanism and varies generally linearly and continuously as the latching mechanism position changes.

The sensor can be a linear Hall effect sensor, and a circuit board can be included to bear it and as a noise filter. The magnet may be overmolded on the wheel or other joining methods may be used.

In another embodiment, a sensor assembly is disclosed that includes a magnet and a magnetic field sensor that do not move relative to each other. A ferromagnetic piece is mounted on, e.g., an eccentric wheel to alter the magnetic field when it moves relative to the sensor assembly. Consequently, the magnetic field sensor of the sensor assembly outputs an electrical signal in response to sensing the magnetic field originating from the magnet. This electrical signal represents the position of the latching mechanism.

In yet another aspect, a system for sensing the position of a rotatable object includes a wheel mountable on the object to move therewith, and a magnetic field sensor juxtaposed with the wheel for outputting an electrical signal in response to sensing a magnetic field. Means are on the wheel for causing a magnetic field at the sensor to change as the wheel and object rotate. The means for causing can be a magnet, or the means for causing can be a ferromagnetic piece having an eccentric radius.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a plan view of the door latch position sensing system according to a first embodiment, showing the latching mechanism in a first position;

FIG. 2 is a plan view of the door latch position sensing system according to the first embodiment, showing the latching mechanism in a second position;

FIG. 3 is a plan view of the door latch position sensing system according to the first embodiment with the latching mechanism removed for clarity and showing the sensing wheel in the first position, with magnetic flux lines shown;

FIG. 4 is a plan view of the door latch position sensing system according to the first embodiment with the latching mechanism removed for clarity and showing the sensing wheel in the second position, with magnetic flux lines shown;

FIG. 5 is a plan view of the door latch position sensing system according to a second embodiment with the latching mechanism removed for clarity and showing the sensing wheel in the first position, with magnetic flux lines shown; and

FIG. 6 is a plan view of the door latch position sensing system according to the second embodiment with the latching mechanism removed for clarity and showing the sensing wheel in the first position, with magnetic flux lines shown.

### DETAILED DESCRIPTION OF THE PREFERRED EMBODIMENT

The present invention is intended for application in automotive door latch systems and will be described in that context. It is to be understood, however, that the present invention could also be successfully applied in many other applications.

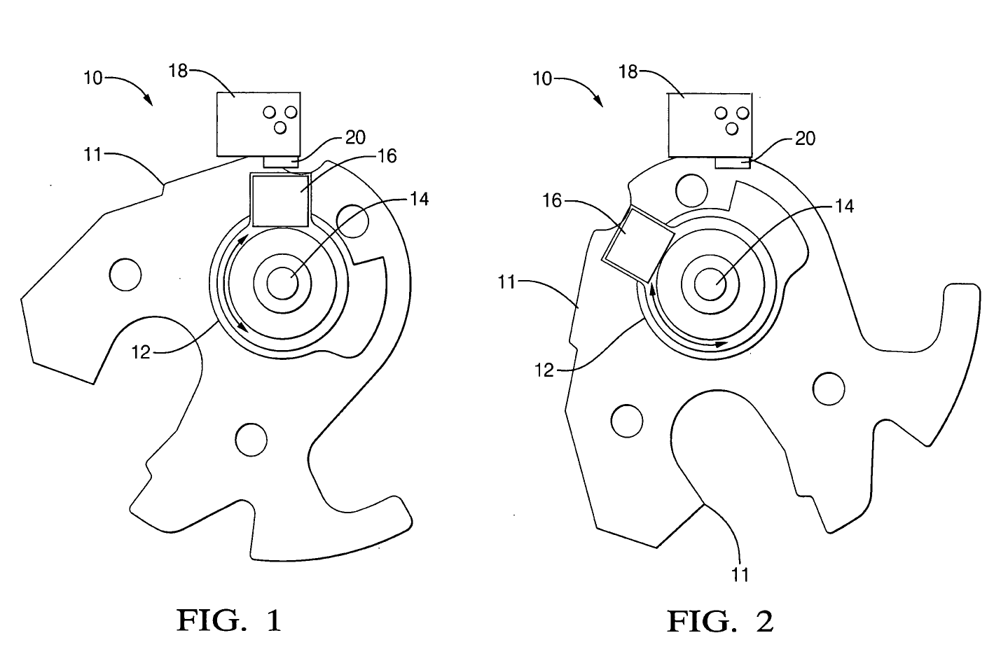

Beginning in reference to FIGS. 1 and 2, a car door locking mechanism, generally labeled 10, is shown. A rotatable door latching mechanism 11 is attached to a door latch system and moves with the door as the door pivots open and shut. The latching mechanism is configured to engage a holding element (not shown) on the body of the vehicle, e.g., on the door jamb, to hold the door shut.

FIG. 1 shows that a preferably plastic sensing wheel 12 has an opening in its middle that fits over a hub 14 of the latching mechanism 11. Other means of engaging the sensing wheel 12 with the latching mechanism 11 can be used, so long as the sensing wheel 12 moves with the latching mechanism 11. A permanent magnet 16 is supported by the sensing wheel 12, and in one embodiment the magnet 16 can be overmolded into the sensing wheel 12, or other joining methods may be used, e.g., it may be mechanically inserted into the wheel.

A circuit board 18 is mounted on the door latch system nearby the sensing wheel 12. A preferably linear magnetic field sensor 20 such as but not limited to a linear Hall effect sensor is mounted on the circuit board 18. The electrical signal that is output by the sensor 20 varies linearly with the magnetic field at the sensor 20, hence with the position of the magnet 16 and, thus, with the position of the sensing wheel 12 and ultimately with the position of the latching mechanism, all of which move in unison. The circuit board 18 can include electronics that receive the signal from the Hall effect sensor 20 and filter out noise, i.e., signals that do not exhibit characteristics that would be expected from sensing the magnetic field. It is to be understood that the circuit board 18 can be electrically connected to a controller such as an onboard engine control module for sending the door latch position signal from the sensor 20 to the ECM, for use thereof.

Moving to FIG. 2, the second position of the door lock generally labeled 10 is shown. The sensing wheel 12 along with the magnet 16 and latching mechanism 11 have been rotated counterclockwise approximately forty-five degrees from FIG. 1. Cross-referencing FIG. 1, the magnet 16 is juxtaposed with the sensor 20 in the first position, whereas the in second position shown in FIG. 2 the magnet 16 is relatively distanced from the sensor 20, thereby changing the magnetic field felt by the sensor 20.

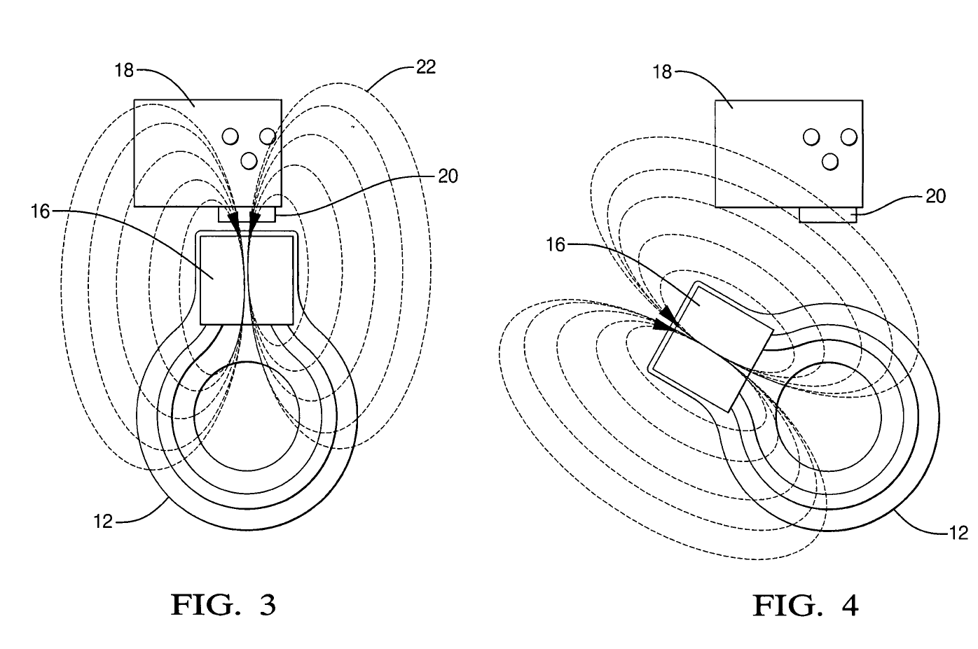

FIG. 3 shows the above in greater detail. As shown in FIG. 3, when in the first position (with the magnet 16 at the top of the sensing wheel 12, closest to the sensor 20 and circuit board 18), the magnetic field lines 22 extend outwardly from the center in an elliptical butterfly pattern, with the amount of flux cutting through the sensor 20 at a maximum. Accordingly, the output of the sensor 20 is at a maximum. In FIG. 4, when in the second position less flux cuts through the sensor as shown. In general, the amount of flux that cuts the sensor 20 more or less linearly depends on the distance of the magnet relative to the sensor, so that it may now be appreciated that the output of the sensor 20 varies generally linearly with latching mechanism position.

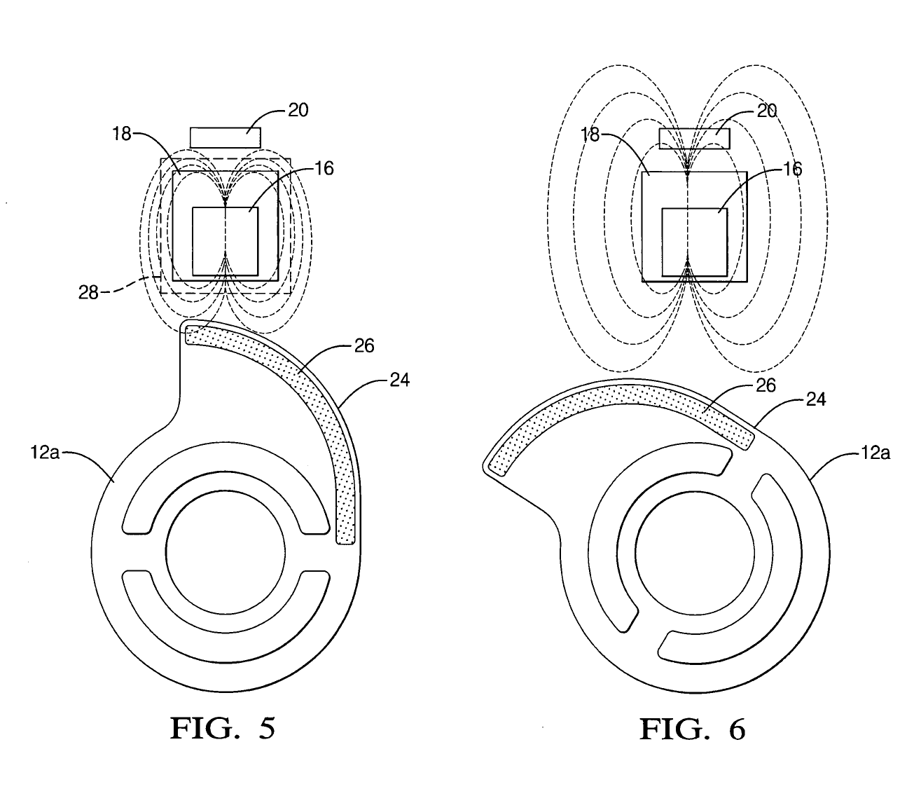

A second embodiment is shown in FIG. 5 and 6, in which the magnet 16, instead of being mounted on a sensing wheel 12a, is stationarily mounted on the circuit board 18 along with the Hall effect sensor 20. To vary the magnetic field 22 as the latching mechanism (and hence sensing wheel 12a) moves, the sensing wheel 12a is made with a cam surface 24, meaning a periphery that is not circular but rather is eccentric. A ferromagnetic piece 26 lies along the cam surface 24 as shown, so that as the cam surface 24 rotates, the distance between the metal piece 26 and magnet 16 changes, changing the magnetic field 22 felt by the Hall effect sensor 20. A single sealed housing 28 can enclose the circuit board 18 with sensor 20 and magnet 16 as shown. While the embodiment shown illustrates a wheel 12a that has a cam surface, what is important to the function of the system is that the radius of the piece 26 is eccentric, regardless of the shape of the wheel.

The piece 26 may be a strip and the magnet may be cube-shaped, although other geometries for the strip and magnet may be used.

While the particular DOOR LATCH POSITION SENSOR as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. Absent express definitions herein, claim terms are to be given all ordinary and accustomed meanings that are not irreconcilable with the present specification and file history.

What is claimed is:

1. A door latch position system, comprising:
one and only one magnet;
a wheel bearing the magnet, the wheel engaged with a rotatable door latch mechanism; and
a magnetic field sensor outputting an electrical field in response to sensing the magnetic field originating from the magnet, the electrical signal representing the position of the door and varying generally linearly and continuously as the door position changes.

2. The system of claim 1, wherein the sensor is a Hall effect sensor.

3. The system of claim 1, comprising a circuit board bearing the sensor.

4. The system of claim 1, wherein the magnet is overmolded on the wheel.

5. The system of claim 1, comprising the door latch mechanism.

6. A door latch position system, comprising:
a support engageable with a rotatable door latch mechanism, the support being formed with an eccentric portion;
a ferromagnetic piece on the eccentric portion; and
a sensor assembly juxtaposed with the support, the sensor assembly including at least one magnet and at least one magnetic field sensor outputting an electrical signal in response to sensing the magnetic field originating from the magnet, the electrical signal representing the position of the mechanism.

7. The system of claim 1, wherein the sensor is a Hall effect sensor.

8. The system of claim 1, comprising a circuit board bearing the sensor.

9. A system for sensing the position of a rotatable object, comprising:
a wheel mountable on the object to move therewith;
a magnetic field sensor juxtaposed with the wheel for outputting an electrical signal in response to sensing a magnetic field; and
means on the wheel for causing a magnetic field at the sensor to change as the wheel and object rotate.

10. The system of claim 9, wherein the object is a door latch mechanism of a vehicle.

11. The system of claim 9, wherein the means for causing is a magnet.

12. The system of claim 9, wherein the means for causing is a ferromagnetic piece having an eccentric radius.

13. The system of claim 12, wherein the piece lies on a cam portion of the support.
